(19) United States
(12) Patent Application Publication
(10) Pub. No.: US 2009/0222509 A1
(43) Pub. Date: Sep. 3, 2009

(54) System and Method for Sharing Storage Devices over a Network

(76) Inventors: Chao King, Fremont, CA (US); Randy Christ, Santa Clara, CA (US)

Correspondence Address: Cameron Kerrigan;SQUIRE, SANDERS & DEMPSEY L.L.P., Suite 300, One Maritime Plaza, San Francisco, CA, 94111-3492, US

(21) Appl. No.: 12/040,561

(22) Filed: Feb. 29, 2008

(51) Int. Cl. G06F 15/16

(52) U.S. Cl. 709/203

(57) ABSTRACT

A distributed data sharing system provides storage areas for network clients. Files are written in such a manner that user data is protected and/or so that the network can make use of any available space at a network when saving files.

### BACKGROUND OF THE INVENTION

1. Field of the Invention

This invention relates to sharing resources over a network and, in particular, sharing storage space among network nodes.

2. Description of the State of the Art and Background

The term “file system” refers to the system designed to provide computer application programs with access to data stored on storage devices in a logical, coherent way. A file system may be understood as a set of abstract data types that are implemented for the storage, hierarchical organization, manipulation, navigation, access, and retrieval of data. File systems hide the details of how data is stored on storage devices. For instance, storage devices are generally block addressable, in that data is addressed with the smallest granularity of one block; multiple, contiguous blocks form an extent. The size of the particular block, typically 512 bytes in length, depends upon the actual devices involved. Application programs generally request data from file systems byte by byte. Consequently, file systems are responsible for seamlessly mapping between application program address-space and storage device address-space. File systems store volumes of data on storage devices. The term “volume” refers to the collection of data blocks for one complete file system instance. These storage devices may be partitions of single physical devices or logical collections of several physical devices. Computers may have access to multiple file system volumes stored on one or more storage devices.

An operating system may be understood as the software that manages the sharing of the resources of a computer and provides programmers and users with an interface used to access those resources. An operating system processes system data and user input, and responds by allocating and managing tasks and internal system resources as a service to users and programs of the system. At the foundation of all system software, an operating system performs basic tasks such as controlling and allocating memory, prioritizing system requests, controlling input and output devices, facilitating networking and managing file systems. Most operating systems come with an application that provides a user interface for managing the operating system, such as a command line interpreter or graphical user interface. The operating system also forms a platform for other system software and for application software. This platform is usually provided in the form of an Application Program Interface (“API”).

Most current operating systems are capable of using the TCP/IP networking protocols. This means that computers running dissimilar operating systems can participate in a common network for sharing resources such as computing, files, printers, and scanners using either wired or wireless connections.

Files are presented to application programs through directory files that form a tree-like hierarchy of files and subdirectories containing more files. Application programs identify files by pathnames comprised of the filename and the names of all encompassing directories. The complete directory structure is called the file system namespace. For each file, file systems maintain attributes such as ownership information, access privileges, access times, and modification times. A “filename” is intended to mean the logical name assigned for the collection of data associated with the file, as understood by a user and mapped to physical, or non-volatile memory by the file system. A logical filename may be referred to as the unique name for the file in a file system's directory, or the concatenation of a logical filename and a logical pathname.

The terms real-data and metadata classify application (or user) data and information pertaining to file system structure data, respectively. Real-data may be understood as the data that application programs or users store in regular files. Conversely, file systems create metadata to store volume layout information, such as inodes, pointer blocks, and allocation tables. Metadata is not directly visible to applications. Metadata can sometimes provide extensive information about who, what, where and when about a file. Metadata may also be stored with the real data by an application, such as the metadata stored with the real data in a Microsoft Word® document.

Some file systems maintain information in what are called File Allocation Tables (“FATs”), which indicate the data blocks assigned to files and the data blocks available for allocation to files. A FAT is a table that an operating system maintains on a hard disk that provides a map of the clusters (the basic units of logical storage on a hard disk) that a file has been stored. FATs are maintained in the Microsoft Windows® operating systems.

Distributed file systems provide users and application programs with transparent access to files from multiple computers networked together. Architectures for distributed file systems fall into two main categories: network attached storage (NAS)-based and storage area network (SAN)-based. NAS-based file sharing, also known as “shared nothing”, places server computers between storage devices and client computers connected via LANs. In contrast, SAN-based file sharing, traditionally known as “shared disk” or “share storage”, uses SANs to directly transfer data between storage devices and networked computers.

I/O interfaces or devices transport data among computers and storage devices. Traditionally, interfaces fall into two categories: channels and networks. Computers generally communicate with storage devices via channel interfaces. Channels typically span short distances and provide low connectivity. Performance requirements often dictate that hardware mechanisms control channel operations. The Small Computer System Interface (SCSI) is a common channel interfaces. Storage devices that are connected directly to computers are known as direct-attached storage (DAS) devices.

Computers communicate with other computers through networks. Networks are interfaces with more flexibility than channels. Local area networks (LAN) connect computers medium distances, such as within buildings, whereas wide area networks (WAN) span long distances, like across campuses or even across the world. LANs normally consist of shared media networks, like Ethernet, while WANs are often point-to-point connections, like Asynchronous Transfer Mode (ATM). Transmission Control Protocol/Internet Protocol (TCP/IP) is a popular network protocol for both LANs and WANs.

Recent interface trends combine channel and network technologies into single interfaces capable of supporting multiple protocols. For instance, Fibre Channel (FC) is a serial interface that supports network protocols like TCP/IP as well as channel protocols such as SCSI-3. Other technologies, such as iSCSI, map the SCSI storage protocol onto TCP/IP network protocols, thus utilizing LAN infrastructures for storage transfers.

The network interface(s) between a computer, DAS storage, network storage or server and the rest of the network is sometimes referred to as a node. A node may also correspond to a network communication device, such as a network switch.

Network architecture is often times understood by reference to a network topology. A topology refers to the specific physical, i.e., real, or logical, i.e., virtual, arrangement of the elements of a network. Two networks may have the same topology if the connection configuration is the same, although the networks may differ in physical interconnections, distances between nodes, transmission rates, and/or protocol types. The common types of network topologies are the bus (or linear) topology, fully connected topology, mesh topology, ring topology, star topology, and tree topology. Networks may also be characterized as de-centralized, such as a linear topology or a peer-to-peer network in which each node manages its own communications and data sharing directly with another node, or a centralized topology such as a star topology. A combination of different topologies are sometimes called a hybrid topology.

A bus topology is a network in which all nodes are connected together by a single bus. A fully connected topology is a network topology in which there is a direct path between any two nodes. A mesh topology is one in which there are at least two nodes with two or more paths between them. A ring topology is a topology in which every node has exactly two branches connected to it. A star topology is a topology in which peripheral nodes are connected to a central node, which rebroadcasts all transmissions received from any peripheral node to all peripheral nodes on the network, including the originating node. All peripheral nodes may thus communicate with all others by transmitting to, and receiving from, the central node only. The failure of a transmission line linking any peripheral node to the central node will result in the isolation of that peripheral node from all others. A tree topology, from a purely topologic viewpoint, resembles an interconnection of star networks in that individual peripheral nodes are required to transmit to and receive from one other node only, toward a central node, and are not required to act as repeaters or regenerators. The function of the central node may be distributed. As in the conventional star network, individual nodes may thus still be isolated from the network by a single-point failure of a transmission path to the node.

### SUMMARY OF THE INVENTION

The invention is directed to embodiments of a Distributed Data Storage System or DDSS. A DDSS may allow one or more clients of a network to more fully utilize storage space available over a network and/or store data while maintaining an adequate level privacy/security for sensitive information contained within the data.

In one embodiment there is a method for data storage of a file among at least a network node A and B using an application including a client-side portion residing at a client node and server-side portion residing at a server node, the file residing at the client node and the client node configurable for separate communication links with each of the server node, node A, and node B. This method includes the steps of the client accessing storage space at the server node after the server recognizes the client as a client of the server, and writing a first data segment of the file to node A and a second data segment of the file to node B.

The writing step includes the steps choosing node A and node B for storage of the first and second data segments, respectively, generating a segment A filename for the first data segment and a segment B filename for the second data segment, and writing Segment A to node A and Segment B to node B. After writing segment A and B, the server saves a map that enables the re-assembly of the file from the first and second data segments.

The map may be meta data including records of filenames and nodes where the associated files may be found, the identity of the owner of the original file, the network address for the owner, the information needed to re-assemble the files from the file segments. The file segments may also be written by a user-selectable degree of redundancy. Each segment may be redundantly stored at network nodes so that if a node become unavailable, a redundant copy is available. The meta data may then include both data segment information and redundant data segment information in the event the redundancies are needed to recover the file.

In one embodiment, the client may read and write data independent of the server. According to this embodiment, the client performs a read and write as it normally would, and regardless of the presence of the server node. The server is called upon only to retrieve the logical filenames and their locations, and the mapping between the plurality of data segments and the ordering of these segments in the original file.

The filenames may be randomly generated filenames. As such, the presence of two data segments of a file in a directory, among other files with randomly generated filenames, would not be apparent to one viewing the directory contents. That is, one could not recognize that the two segments were taken from the same file. The two data segments, if located adjacent to each other according to an application's mapping of the data in the file, are preferably not written to the same node. This will make it more difficult to discern a relationship between the two data segments.

The nodes where data segments are written may be determined by the server node and recommended to the client. The server may select nodes based on at least one of the following criteria: the level of network traffic at a node, the number of packet errors per transmission to/from a node, the type of storage medium at the node, and the type of communication link(s) between the client node and Storage device(s). The server may recommend nodes to a client by a assigning a node score for each node. The client may then select the nodes that exceed a threshold node score.

The server may provide the information on the available nodes and the filenames for storing segments. In other embodiments, a client side module may provide one or both of these functions, in which case the server may only serve as a secure databank and client account manager for the DDSS. The client may select the number of segments independent of the status of nodes, and then write segments to nodes based on their availability only. The client may also generate the filenames and match those filenames to nodes. Under these embodiments, the client module would utilize a random generation of filenames routine and node selection routine. The meta data would only be stored in virtual memory, and after a successful write the information would be sent to the server for storage and then erased at the client node.

The map file, or the DDSS meta data may be located only at the server and stored so that only the owner of the file has access to the information. The map file may be stored in a password protected storage at the server, or encrypted at a site accessible to other nodes on the network.

The client node may be configurable for separate communication links with a plurality of nodes, including at least the server node, and nodes A and B. A method according to one embodiment may further include the steps of the client requesting from the server the available nodes for data storage and then receiving from the server the availability of the plurality of nodes, the client segmenting the file into Segments A and B based on the availability of nodes A and B, and the client writing Segments A and B to the respective nodes A and B, and a copy of the Segment A to a different one of the available plurality of nodes. An application resident at the client node may request the file, which may be retrieved by accessing segments and one or more redundant copies of segments until the file can be fully re-assembled and passed to the application.

In another embodiment, a file storing method for storing a file over a network having a plurality of storage devices at network nodes, the file containing real data, includes the steps of partitioning the real data into a plurality of real data segments, generating a random filename for each one of the real data segments, associating each of the real data segments with its respective randomly generated filename, and storing each of the real data segments on one of the plurality of storage devices. The storing step may include storing the metadata needed to reconstruct the file from the data segments at a restricted node on the network, which is accessible to only the owner of the file. Further, the real data segments may be partitioned from the file according to a sequential order according to their relative byte locations in the file, and the real data segments are stored on one or more of the plurality of nodes in one of a random, intermittent or non-sequential order. A sequential ordering of the bytes can be the order in which an application orders the information in the file.

A DDSS may be implemented on any network topology and storage areas that can be accessed over a network. DAS or network storage can be included as DDSS storage areas. In another embodiment, a computer network includes a client node wherein the client is the owner of a file, a plurality of nodes, each node including a storage space accessible by way of a first communication link comprising communication links between each of the nodes and the client node, a plurality of data segments, wherein one or more of the data segments are stored on each of the plurality of storage spaces, a server node having a storage wherein only the server storage has a map enabling the re-assembly of the file from the data segments, and a second communication link between the client and the server such that the client is enabled for accessing the information needed to re-assemble the file when the client wishes to re-assemble the file from the data segments.

A computer network may include a plurality of redundant nodes storing redundant data segments. In a method for a computer to access data associated with a user's file, the data being stored as a plurality of data segments distributed over a network having nodes, and as a plurality of copies of the data segments over the nodes, includes the steps of the computer requesting from a network node the locations of the data segments and copies of data segments, and the computer accessing a node in order to retrieve a data segment. If the data segment at the node is inaccessible, then the computer attempts to access a different node where a redundancy of the segment is stored. This process is repeated until a copy of the segment is accessible to the computer.

In some embodiments a DDSS is run by application programs that are loaded and run over a local operating system, and perform read/write information based on filesystems managed by the local operating system. The application may include a DDSS server module. DDSS clients may be added by downloading a client module from the server.

In another embodiment, software residing on a storage medium and adapted for providing server-like functions includes a first portion for selecting a plurality of network nodes for storing data portions over a network, wherein data in a source file comprises the data portions, a second portion for selecting a filename for each of the data portions, a third portion for storing the relationship between the filenames and the nodes where the data portions reside, and the relationship between the data portions and the data in the source file in a map file, and a fourth portion for limiting access to the map file to only the owner of the source file.

In another embodiment, software residing on a storage medium and adapted for providing client-like functions includes a first portion for selecting a number of data segments for writing data from a source file, the data comprising the data segments, a second portion for receiving filenames for each of the data segments, and the nodes over a network for storing each of the data segments, a third portion for writing the data segments to a plurality of nodes using a communication link between a computer where the client software resides and each of the respective nodes, a fourth portion for communicating the relationship between the filenames and the nodes where the data portions reside, and the relationship between the data portions and the data in the source file, and a fifth portion for gaining access to a map file on a network node, the map file containing a previously communicated relationship between filenames and the nodes where the data portions reside, and the relationship between the data portions and the data as it existed in the source file.

According to some embodiments, after a write attempt is detected or a write request is sent to the server, a server module and a client module together perform a DDSS write process. This process includes transferring the real data in a file to the DDSS storage space assigned to the client. The real data is segmented and stored in different files called file segments. After the real data has been written to these file segments, the real-data is removed from the client's computer. The order, locations and/or logical names for the file segments holding the real data portions may not be sequential or relatable to one another. Rather, they are written such so that a mapping is needed in order to understand where the components of the file are located, and the order in which the file is re-assembled from the file segments. This DDSS meta data is stored in physical memory only at the DDSS server, which is password protected.

In some embodiments, a network includes a plurality of DDSS nodes for storage and a plurality DDSS clients. Some of the nodes may also be clients. The plurality of DDSS clients and nodes may access their respective DDSS meta data at a primary server. The primary server includes a password-protected site for the meta data associated with each of the clients' files. The meta data contains the information about the clients' files necessary for re-assembling the files from file segments. Alternatively, meta data for each clients' files may be stored in an encrypted file that is read into a client's or the server's cached memory when a client initiates a DDSS session. The primary server includes software for maintaining client accounts. In the event that the primary server becomes unavailable, one or more secondary servers can be called and serve in place of the primary server. The secondary servers can be local servers designated to manage only a subset of clients.

A DDSS may be implemented within a peer-to-peer or server-less network environment, as well as within a centralized network environment. In some embodiments, a DDSS server and client(s) may be configured by installing and running respective server and client applications on a designated server that interfaces with an operating system's application program interface (“API”). In these embodiments, the DDSS can be initiated or terminated like other programs, and have access to system resources through the API like any other application program.

Preferably, file segment information is only viewable by someone with administrative rights at the DDSS server. Thus, no user at a client node may see where its file information is stored, and the client module only has temporary access to this information. Thus, even user's interacting with DDSS clients have no way of seeing where the actual files were stored, the filenames used, the partitioning of data, etc. Information for accessing the actual files and locations are kept in nonvolatile memory only at the DDSS server. The DDSS client is provided with the mapping information it needs only when a valid read/write request is made, but the information necessary to make system calls through the DDSS client operating system, or network server operating system, is only maintained in temporary memory. In this way, file locations are only known at the DDSS server. After a successful read/write is made, information pertinent to the read/write is reported back to the DDSS server and then removed from memory at the DDSS client. Thereafter, the same file can be accessed only by requesting the information again from the DDSS server. However, at no time may a user of the computer designated as a DDSS client view the segment filenames or paths for the read/write, only the logical filename that represents the segmented data as a single file.

A DDSS may provide a level of security and privacy as a replacement for data encryption methods. A DDSS may segment files into smaller and smaller segments, distributed over a wider set of nodes to achieve an increasing level of privacy protection as a replacement for data encryption. DDSS file storage, however, can be less machine intensive since the data need not be encrypted and decrypted in connection with each write and read request.

A DDSS can store data on remote DAS devices, which may reside at a node operated by a user unknown to the client. However, the DDSS may be configured to select a desired level of privacy protection to the information described in the stored data. A user at a DDSS client node need not be concerned with whether sensitive information described in a file and written to another user's local storage being accessible to the other user because only a portion of the file is written to the other user's device, and a file or a portion thereof is broken up among a plurality of files on other nodes not normally accessible to the same user. As such, files may be segmented and distributed such that no one file can convey meaningful information to a user with access to local files. Only when file segments are combined will the assembled data convey meaningful information.

Meaningful information” is intended to mean information that is capable of conveying a concept, idea, thing, person, etc. to someone who has access to the data. For example, if text in a natural language, e.g., English, is stored according to the DDSS, only a portion of the text may be written to a single node, but this data does not contain a sufficient portion of the text to communicate any meaning in the natural language, much less suggest what information is conveyed in the remainder of the data. The information may be sufficiently distributed out among separate files, called file segments, distributed out over one or more network nodes in a random pattern and with randomly generated filenames, to provide a desired level of security for sensitive information in accordance with this aspect of a DDSS. Other file security measures known in the art may be included, such as encryption, without departing from the scope of this disclosure.

### BRIEF DESCRIPTION OF THE DRAWINGS

FIG. 1 is a schematic illustration of a first embodiment of a distributed data sharing system (“DDSS”) for a network.

FIG. 2A is a schematic illustration of the components of a server-side module portion of the DDSS of FIG. 1.

FIG. 2B is a schematic illustration of the components of a client-side module portion of the DDSS of FIG. 1.

FIG. 3 is a flow process associated with writing a file to memory according to a DDSS.

FIG. 4 is a flow process associated with retrieving the file written to memory according to the process of FIG. 3.

FIG. 5 is a flow process associated with updating or overwriting the file written to memory according to the process of FIG. 3.

FIG. 6 is a schematic illustration of DDSS meta data.

FIG. 7 is a schematic illustration of a second embodiment of a DDSS for a network.

### DETAILED DESCRIPTION OF THE INVENTION

Devices connected over a network will often have significant portions of unused storage space because the local storage space are not readily available over the network. For example, a Local Area Network (“LAN”) for an enterprise will often include devices such as personal computers (“PCs”), file and print servers, each of which can have significant local data storage capacity. The term “local storage capacity” is intended to mean a storage medium, such as a magnetic disk, that is available to a device when it is not connected to the network.

This local storage capacity is typically not available to members of the network. This is especially true in LANs that require all files located on a network server drive so that the file is readily available when needed, can be tracked and backed up on a regular basis, and will be available when a network device is not available, e.g., when the device is turned off or not functioning properly. In most cases, an enterprise will also prefer central storage over local storage for purposes of more easily managing access and/or viewing rights of files and related protection of sensitive enterprise information. As such, one or more devices connected over the network can have significant storage capacities that are never exploited because enterprise files are maintained at a central server location rather than locally.

Despite the vast increases in storage capacities over the years, network servers can still prove inadequate for a storage demands over a network. Moreover, even when space is adequate on the server drive, simultaneous read/write demands on the server drive from network nodes can result in exceedingly slow upload and download rates to/from nodes over the network. Attempts have been made to increase the server response time or to more efficiently allocate resources by e.g., implementing schemes for caching more frequently accessed data over the network.

The invention is directed to embodiments of a Distributed Data Storage System or DDSS. A DDSS allows network clients to access devices at node(s) located on, or accessible to the clients (hereinafter referred to as “DDSS nodes”, “available nodes” or simply “nodes”). This increases the available storage space over the network by utilizing storage space that would otherwise be wasted. In some embodiments, the DDSS may be used to store information over remote DAS devices that individually do not have the space to store the file or whose read/write capability is not suited for a large file.

In some embodiments a DDSS provides a read and write capability for user data to nodes in such a manner as to maintain a level of privacy and/or confidentiality for a user's data without resorting to procedures requiring verification of, or granting privileges to a user whenever a read and write call is made to a storage device. Client data may be protected by partitioning the real-data associated with a user filename into several data segments, and then saving these data segments across the available, or a portion of the available nodes on a network. User data is accessed through these segments, and data modified is re-saved in the same or different segments depending on the current availability of nodes. In some embodiments data segments can be saved redundantly in the event that a node becomes unavailable to the DDSS.

In one embodiment, a DDSS is implemented as a DDSS server located at one node of a network and DDSS clients are located at one or more other nodes. The network may be a peer-to-peer or server-less network, or a network in which one or more dedicated servers, e.g., print, file, e-mail, are connected at one or more network nodes. A DDSS server and client(s) according to this embodiment may be configured by installing and running respective server and client applications over the operating systems located at each of the respective designated server and client nodes. In this embodiment, the DDSS can be initiated or terminated like other applications resident at network nodes, and can access a computer's system resources through an operating system's application program interface (“API”).

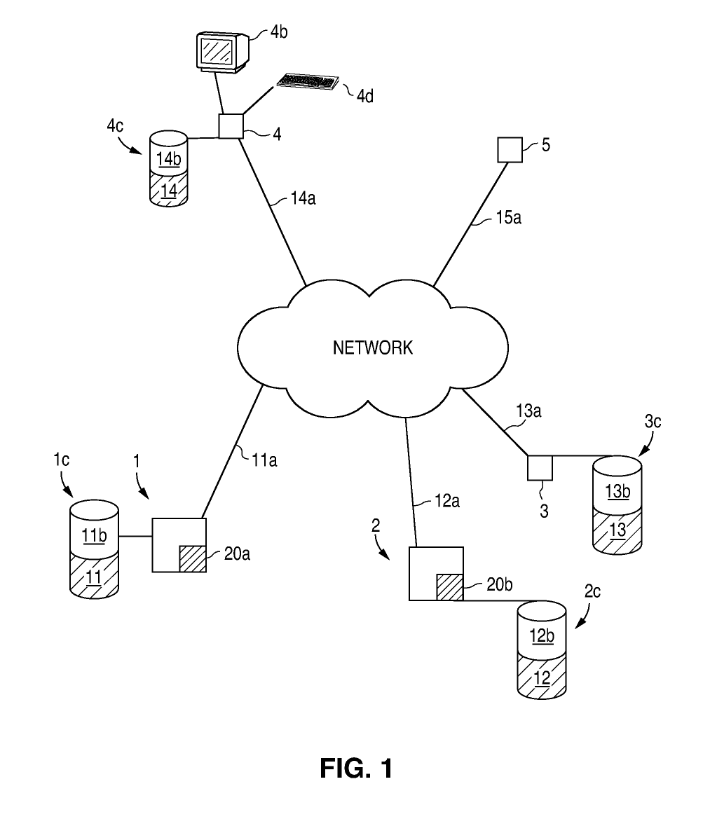

FIG. 1 is a schematic illustration of a network having a DDSS capability. Node 1 is designated as a DDSS server node and node 2 a DDSS client node. A DDSS server module application (“server-module”) 20a is installed at node 1; and a DDSS client module application (“client-module”) 20b is installed at node 2. The server-module and client-module interact with each other when a user at the client node 2 requests a DDSS read or write. It will be understood that nodes 3, 4, and 5 may also be designated as DDSS clients. Further, node 1 may be designated as both a DDSS server and DDSS client. Finally, the number of network nodes that may be part of a DDSS is not limited to the five depicted in FIG. 1. Thus, the five nodes depicted in FIG. 1 should not be interpreted to indicate that a DDSS is limited to smaller networks. Indeed, a DDSS may be most useful on large networks where there are several nodes that can be utilized by the DDSS for storage, and data may be more widely dispersed to maintain confidentiality/privacy of data.

Connection 11a, 12a, 13a, 14a and 15a may correspond to a connection over a LAN or WAN. The connections may be made by physically connected nodes, such as through routers, switches, hubs and network servers. A node may function as both a DDSS server and a network server. Some connections may be made by way of a wireless connection, or a mix of wireless and physical connections among nodes. Standard network communication protocols may be used to communicate and transfer data according to a DDSS.

Each node may connect to a variety of computer types, such as a workstation or multi-function printer. For example, node 4 connects a computer having an I/O device such as a keyboard and/or mouse 4d, and monitor 4b. Other nodes in the network may connect to a server computer, workstation, and/or a Personal Data Assistant (“PDA”), etc. Nodes 1, 2, 3 and 4 have a local storage capacity as designated by storage icons 1c, 2c, 3c and 4c. Nodes may be DDSS clients, but with only minimal local storage capacity, such as node 5, or where local storage that is not accessible to the DDSS over the network. One example would be a thin client, such as a terminal, or a device whose filesystem is incompatible with a filesystem of a DDSS client. A node may also connect to a computer blade having local storage, processor, motherboard, operating system, etc., but no I/O device other than a network I/O device.

Storage at DDSS nodes 1, 2, 3 and 4 is indicated by storage areas 1c, 2c, 3c and 4c, respectively. A storage device, e.g., storage device 1c, may correspond to a single device, or a cluster of devices organized in a logical way so that they may be part of a single namespace. Each of these storage areas are partitioned between a portion 11a, 12a, 13a, 14a and 15a restricted to a local account and a portion 11, 12, 13, 14 and 15 accessible to the DDSS server and client(s) over the network. Portions 11, 12,13,14 and 15 may be made accessible to the DDSS server and client modules 20a, 20b by way of any suitable file sharing utility known in the art. One example is the file sharing utility provided in the Microsoft Windows XP® operating system's file sharing utility. Standard network and channel protocols may be used to transfer data to/from the server, client and storage devices, as well as to communicate commands or requests over the network as known in the art. Thus, it is understood that the disclosed DDSS may be implemented using existing network architecture, including the communication and data transfer protocols used by networks.

The DDSS selectively accesses storage areas 11, 12, 13, 14 and 15 at the available nodes, which may include network or DAS storage devices associated with a node. A storage device may include such physical memory devices as magnetic or optical storage mediums, solid state or any other suitable device that provides physical storage space. DDSS storage space may also reside at remote storage area(s) connected to a node through another network connection. For example, node 3 may be a NAS server connected to clusters of storage devices 3c or another network having a plurality of additional available nodes. The storage spaces may be DAS devices accessible through a local operating system that grants read/write privileges to the DDSS over the network. Both DAS devices and network storage, e.g., central server, SAN, NAS or SAN-NAS hybrid architectures, network printers, e-mail and file servers, etc. having a storage capacity may be included among the storage spaces accessible to the DDSS.

A DDSS may be added to an existing network by a DDSS initialization routine, which may be directed through a DDSS server computer, e.g., node 1, a computer which has an installed DDSS server module 20a. The DDSS initialization procedure includes mapping a portion, e.g. a folder, directory or volume, of the DDSS server storage space to the DDSS clients' filesystems. Thereafter, the DDSS client(s) may access its assigned portion of the DDSS server space. The client's allocated DDSS space may be added to the client's filesystem as a new volume included in, e.g., the client's File Allocation Table (“FAT”).

DDSS initialization also includes mapping the storage space available to the DDSS over the network, e.g., mapping the space 11, 12, 13 and 14. In some embodiments, this storage space is directly mapped to both the server's file system and each of the clients' filesystems. In these embodiments, both the client and the server can access the storage space independently of each other. Further, because the client's computer's filesystem may include a mapping of its allocated remote storage space, the client computer's operating system may read data from, or write data to the remote storage space just as it would for any other device. Remote space may be added as new volumes included in the server's and clients' FATs.

In some embodiments, the server may access the DDSS storage space to perform operations such as removing files that were not properly replaced or updated due to a system crash at the node or over the network. The server may also access nodes for purposes of monitoring the network traffic to/from a node, as will be explained shortly. Clients may only perform a read and/or write for files located in their allocated DDSS storage space. In some embodiments, at both the server and client nodes there may be an administrator account that has greater access rights than a client to the DDSS server storage and/or the storage space at the nodes. The administrator account may be used to re-partition storage space among clients, remove old files and/or clean-up DDSS storage space, re-initialize the DDSS, restore files (either DDSS server or DDSS client data) from a remote backup, add/remove a node to the DDSS, add/remove DDSS clients, servers, etc.

Clients may be created/added to the DDSS by downloading a copy of the DDSS client-side application (e.g., client module 20b) from the DDSS server-side application (e.g., server module 20a). Initialization of a client through the client module may include such steps as creating a client account at the server side, setting up a client quota of storage space, creating a password for accessing the DDSS, selecting a directory or folder location on the client computer for storing DDSS-related files, etc. The initialization process would also include mapping the server storage space for the client to the client's filesystem, and the mapping of the remote space allocated to the client, either directly or through the server (as discussed earlier).

Once initialized the DDSS can be accessed by the clients. The server application is preferably running continuously, whether or not there is a client session in progress. Most of the DDSS server space may be mirrored in cached memory to increase speed. This can be possible because most of the DDSS server space contains only information about files, such as the metadata and file names, as opposed to the real data contained in the files. The contents of the server space may be frequently written to a designated backup device in the event that the server computer becomes unavailable. In a preferred embodiment, a file once saved to DDSS is removed from the client's storage space. Thereafter, the client's file is accessible through the DDSS storage space and backup.

In the event the DDSS server computer fails, or the server node become inaccessible, or the server node becomes unavailable to one or more clients, one or more secondary or backup DDSS servers may be called upon to act as DDSS servers until the primary server is available again. In these embodiments, a DDSS session may include periodic updates to the secondary, or backup DDSS server(s), which are installed and resident in memory at the designated backup server but otherwise inactive until the primary DDSS server becomes unavailable. When the primary server becomes unavailable to one or more nodes, the backup servers may be notified of this event through frequent “pings” of the server node, or by a message received from one or more client nodes. When so notified, the backup server would retrieve the DDSS server's files and/or client files from a backup device, and run in place of the primary server until communication with the primary server is regained.

In some embodiments, the DDSS may have a secondary or backup server module component to a client node installed within proximity to a logical grouping of client nodes. For example, suppose a business located in a building has three floors and each floor defines each logically grouped domain or node cluster for the network (e.g., a sales, marketing and design domain of the network). Each floor may designate a backup which, in the event of failure of the DDSS primary server, acts as a local backup DDSS server to server the nodes on that floor.

The DDSS server may maintain information about a DDSS client in a client account record managed by server-based account manager utility. A client account record may include such information as a network node address, the client's viewing or access rights to the server storage space and/or remote devices, the client's quota of storage space, the location(s) of backup files, and client verification information when a DDSS session request is received from a node, e.g., a password and node associated with the client. A viewing right refers to a right to see files, folders and/or directories, but not inspect their contents. An access right gives the right to view at least a portion of the contents of a file. In some embodiments, clients may be given access rights to some files, but only viewing rights to others when directories are shared between different clients. In some embodiments clients may view and access files only at the client's allocated root directory and directories below the allocated root directory.

A DDSS session request would be initiated by the client, e.g. at node 2 in FIG. 1. The user accesses the login screen provided by a client-side application, e.g., client module 20b, and enters the password for the DDSS client for that DDSS node. The server-side application, e.g., server module 20a, receives a request for a session with an accompanying password and node ID. The received node and password are checked against the client account records to verify that a user is submitting a valid request for access to the DDSS for that node. When the correct information is received, the server grants read/write privileges to the client node's portion of the server space.

Client accounts may also include information that is needed to re-initialize DDSS connections, increase or decrease the space allocated to a client and other client-specific information needed by a server. Some of this information may also be available through a network server or manager. After a client has successfully logged-into the DDSS the user at the client node may read data from, and write data to the DDSS storage space in the manner that it is accustomed to under the client's operating system. The DDSS space is mapped to the client's filesystem as one or more volumes. One filesystem and associated namespace structure that can be used to map to one or more networked computers is the Microsoft Windows XP® operating system's file sharing utility. Other commercially available applications that interface to an operating system's API to provide a user with file-sharing capabilities among one or mode nodes connected over the network may also be used.

As such, a DDSS read/write capability, as explained next, may be readily implemented over an existing network. A network user would only need to manage its local filenames and directories under the DDSS device(s) as it would for any other device in its filesystem. The third person pronoun “it” is intended to refer to either a real person interacting with a client computer through a local I/O device, such as a mouse, or a remote computer that accesses the client computer. As such, “user” under this disclosure may be either a real person or a computer that remotely controls a DDSS computer at a network node.

A DDSS read and write process will now be described with reference to the network depicted in FIG. 1. The computer, e.g., a multi-function printer, at node 1, in FIG. 1 has installed a server module 20a and is designated as the DDSS server. Similarly, the computer, e.g., a PC, at node 2, has installed client module 20b and is designated as a DDSS client. As DDSS server functions (as implemented through server module 20a) use resources at the node 1 computer, computer resources such as its operating system, storage devices, virtual memory (e.g., static and dynamic RAM), I/O devices, etc. at node 1 will, for the sake of convenience, be referred to as the DDSS server operating device, memory device, etc. Similarly, As DDSS client functions (as implemented through client module 20b) use resources at the node 2 computer, its computer resources will, for the sake of convenience, be referred to as the DDSS client operating device, memory device, etc. Computer resources of a server and/or client, respectively, may be shared with other network tasks, e.g., local e-mail sending/receiving and internet activities. Thus, the designation of, e.g., a server storage or I/O device, should not be interpreted as a DDSS-dedicated storage or I/O device, although in some embodiments these devices can be dedicated to DDSS related tasks.

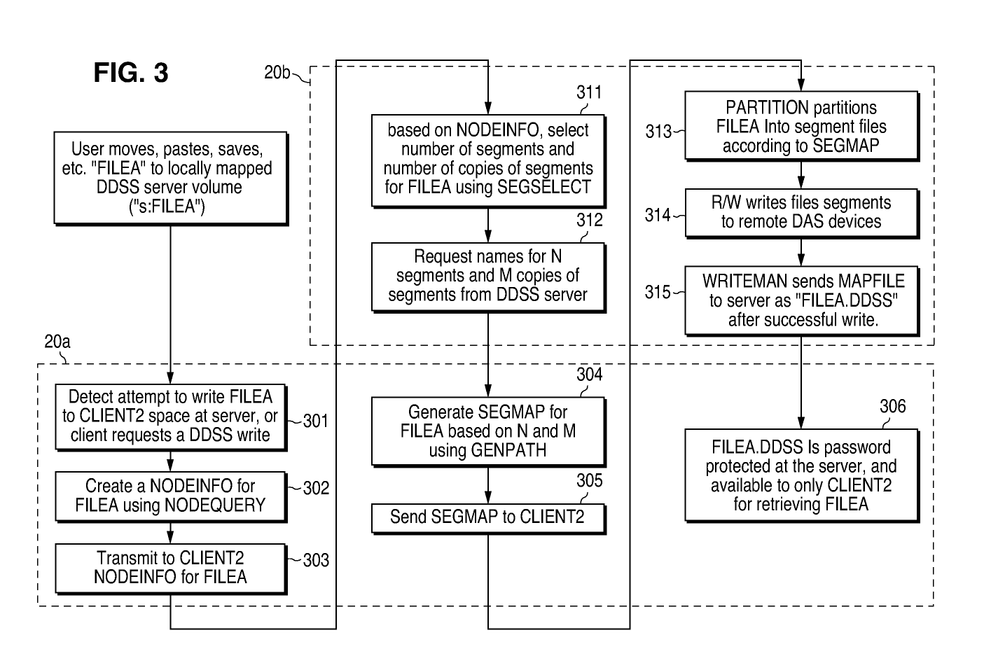

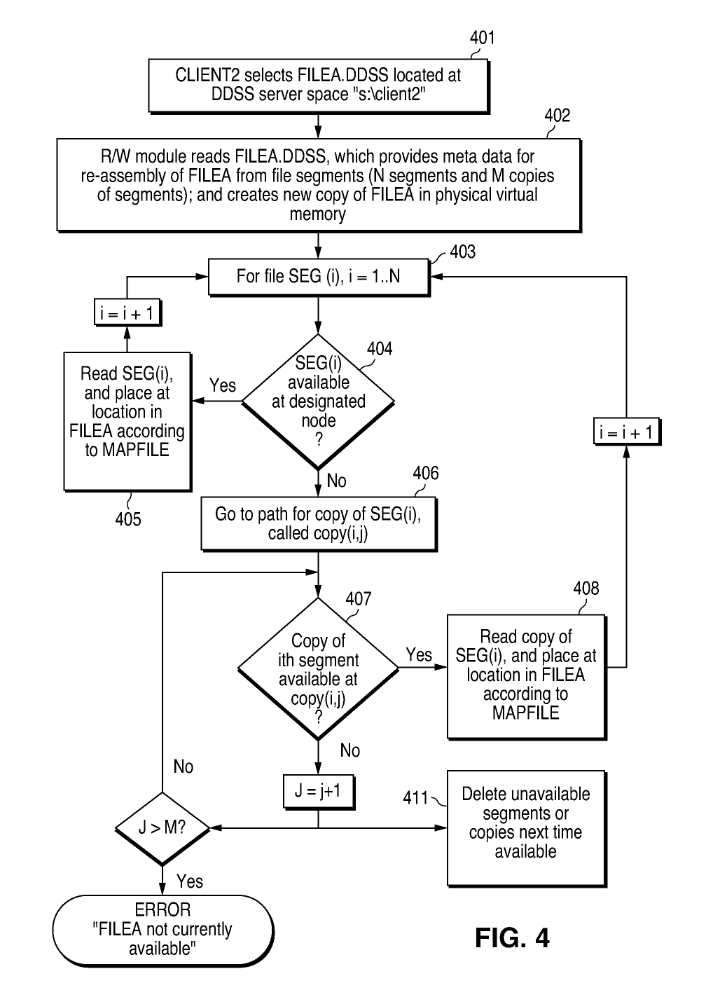

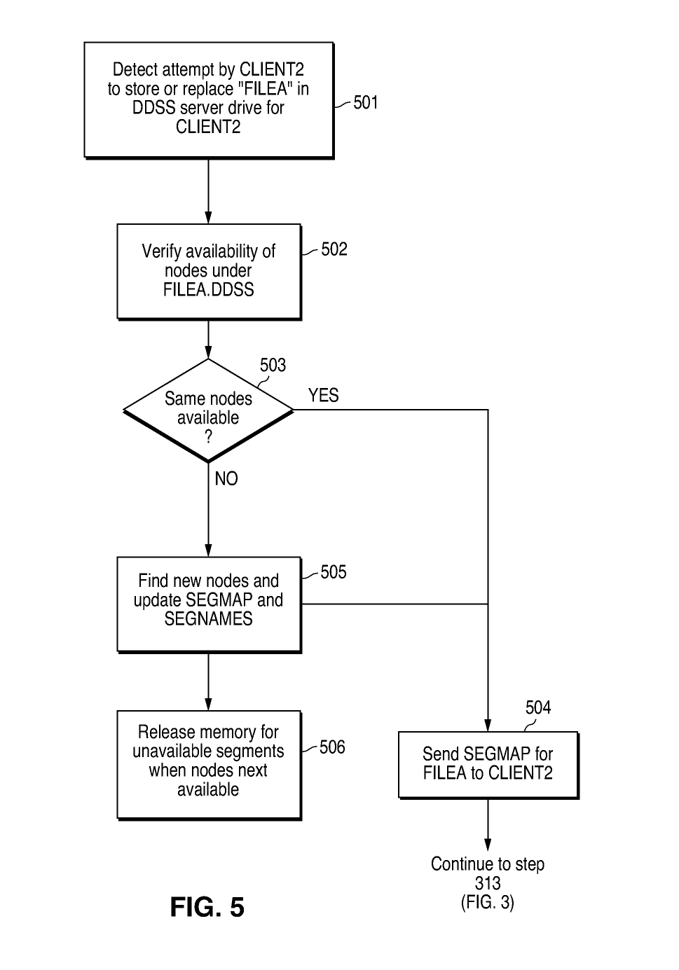

Both the server module 20b and client module 20a may perform tasks associated with storing a user's file according to a DDSS write process (FIG. 3), a read process (FIG. 4), and a file modify process (FIG. 5).

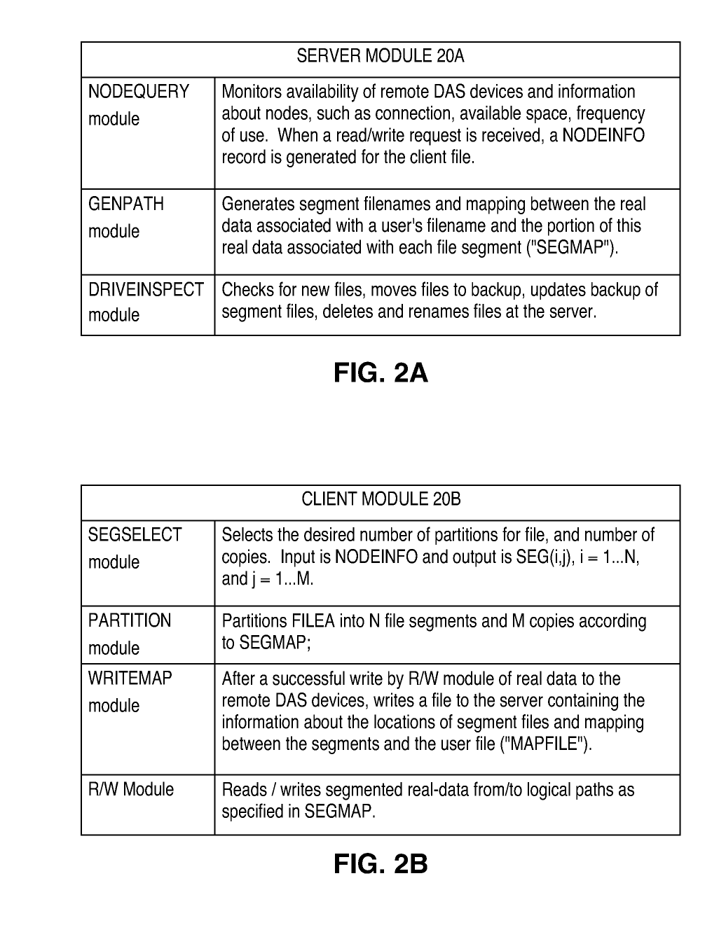

FIGS. 2A and 2B are tables describing tasks associated with the client module 20b and server module 20a. The client module 20b includes a SEGSELECT module, PARTITION module, WRITEMAP module and R/W module. The server module 20a includes a NODEQUERY module, DRIVEINSPECT module, and a GENPATH module. As discussed earlier, the server module may also include an account manager utility for managing client accounts. As will be understood read/write related tasks may be distributed differently between the server module 20a and client module 20b. Thus, it should be understood that the functions associated with a particular module, as depicted in FIGS. 2A and 2B need not all reside in that module, or entirely with the server and client, respectively. Rather, it is contemplated that tasks may be assigned or shared differently among modules, and/or additional modules may be used to perform some of the tasks assigned to one module. In some embodiments, client module 20a may perform tasks 311-315 of a write process, and server module 20b tasks 301-306 as depicted in FIG. 3.

A user at node 2 (“CLIENT2”) wishes to store a file in the DDSS. This process may be initiated by the user simply initiating a write procedure at the DDSS server space assigned to the client, which is detected by the server. The write may not be carried out in whole or in part, but rather suspended and re-directed by the client module. The client module, with the assistance of the server module, will then direct the write to the DDSS storage space according to a DDSS write process.

The client's DDSS storage space will be called “s:\node2”. The server may be notified of the write attempt either by its operating system detecting a system call, or by a write notification received from the client. The file may have been generated by an application resident at the client computer, or an existing file that is being moved to s:\node2. The logical name of this file in the CLIENT2 filesystem will be “FILEA”.

After the write attempt to detected or a write request is sent to the server, the server module 20a and client module 20b perform the DDSS write process. This process includes transferring the real data in FILEA to the DDSS storage space assigned to CLIENT2. The real data is segmented and stored in different files called file segments. After the real data in FILEA has been written to these file segments, the real-data is removed from the client's computer. The order, locations and/or logical names for the file segments holding the real data portions may not be sequential or relatable to one another. Rather, they are written such so that a mapping is needed in order to understand where the components of FILEA are located, and the order in which FILEA is re-assembled from the file segments. This DDSS meta data is stored in physical memory only at the DDSS server, which is password protected.

When the server detects, or is notified of a write request, the file logical name, and size, and the node requesting the write is reported to module NODEQUERY. This module is tasked with surveying all remote storage space accessible to the DDSS, and choosing from among the most preferred nodes for writing FILEA. Hereinafter these devices or storage spaces, accessible through the nodes of the network, shall simply be called “nodes”. Thus, in FIG. 1, the DDSS has four nodes for storing data, or four nodes having storage space, because at each of the nodes 1-4 there are respective shared storage devices 1a, 1b, 1c, 1d having DDSS accessible storage spaces 11, 12, 13 and 14.

NODEQUERY includes a node prioritization algorithm that prioritize nodes for storage based on a variety of factors. For example, the nodes given the highest priority for storage may be the nodes that are connected through a high bandwidth connection, nodes that have the lowest rate of packet errors, nodes that are located relatively close to the DDSS client, and so on. Nodes may also be prioritized by the amount of network activity at the node, or read/write requests on the storage device(s) connected to the node. Thus, a node that is currently not being used may be chosen over a node that is experiencing a high volume of read/write requests. NODEQUERY may at regular intervals “ping” each DDSS node so that it will have on-demand information about the level of activity at every DDSS node when a write request is received from a client.

A node may be given a lower priority if it has a small amount of available disk space relative to the size of FILEA. A node that is currently not available, e.g., because the device at the node is disabled, would be excluded from the list of nodes under consideration. NODEQUERY may also notify a client in response to a write request that FILEA exceeds its allocated DDSS space. This information may also be communicated to the user prior to notifying the server that a DDSS write is requested.

A prioritized list of nodes for storage of FILEA is created at step 302 and held in NODEINFO. This array of node information may simply provide a prioritized list of nodes and the available space at each node. At step 303, NODEINFO is sent to client module 20b.

At step 311 client module 20a selects, based on the information in NODEFINO, the amount of partitioning for FILEA. The partitioned real data in FILEA is organized into data segments. The number of data segments for FILEA may be based on at least one of privacy concerns for the user's data, the available space, and the rate and/or manner at which data can be written to a remote device (e.g., block size for reading/writing). For example, if FILEA is segmented across all available nodes, then no one node has any portion of data from FILEA that can provide any meaningful information about the contents of FILEA because the data is widely dispersed over the network. Additionally, several file segments may be written to the same device to further distribute the real data. The amount of segmentation may also be based only on the available space at the various nodes. Thus, FILEA may be partitioned into several segments so that its contents can be stored at the available nodes.

Step 311 also includes the selection of the number of copies of each data segment that will be stored over the network. Copies of each data segment, stored on separate nodes, may be desirable as a way of ensuring that if a data segment stored at a node later becomes unavailable, the copy can be accessed at a different node. As such, a DDSS may be configured so that there are several layers of redundancy for file segments, spread over the nodes, so that a segment not available at one node will be available at another node.

In some embodiments, client module 20b may have a fixed number of segments and copies for a file, based on its size. In this case, the client module selects up to this number of segments and copies, or the maximum number of available nodes for segments and copies under NODEINFO, whichever is less. In some embodiments, the client module may select the number of nodes based on a block read/write size, which selection parameter may lead to increased efficiency during a read/write from nodes.

In some embodiments, client module 20b may be configured to select all nodes that are above a threshold node “score” provided by NODEINFO. A node score is intended to refer to a ranking of the nodes based on a variety of factors, such as the average speed of the connection (i.e., bytes per second), type of connection (e.g., wireless, optical, etc.), the average response time to a “ping”, number of packet errors per transmission, and the computer or device type at the node. In some embodiments, the client module 20b may contain a user-selectable number of segments and/or copies of segments.

At step 312 the client module 20b informs the server module 20a that FILEA will be segmented into “N” number data segments and “M” number of copies based on NODEFINO.

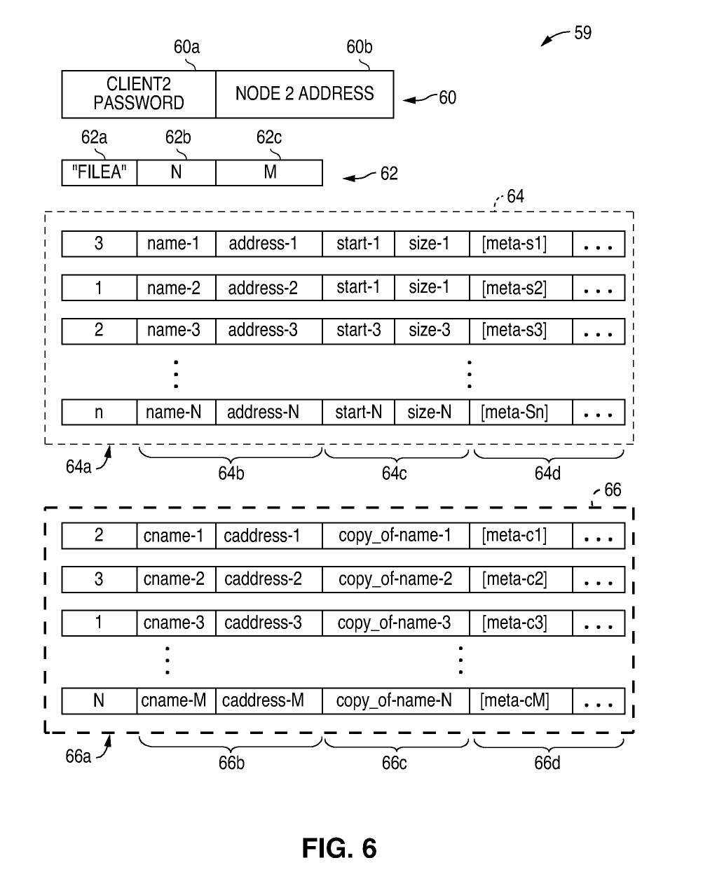

When the requested number of data segments and copies are received at the server, the GENPATH module is used to generate names for each of the file segments that store the real data from FILEA, and the corresponding logical names and addresses for the file segments. Preferably, the file segment names are randomly generated so that a user, other than the file owner, who views the written file segments without access to the FILEA meta data, cannot discern from the segment filenames what file they originate from, the order in which the real data in the segments should be combined to re-create FILEA, or whether the file segments are even related to each other. In essence, the file segments may be stored such that the portion of the real data in a file segment is worthless without the DDSS meta data to at least locate the parts of the original file. One example of DDSS meta data for FILEA is shown in FIG. 6.

In some embodiments, GENPATH may include a random number generator used to derive a random filename. For example, any suitable pseudo random number generator that returns a random number, e.g., a real number over the interval 0 to 1, may be used to randomly select each letter, number and/or symbol that when combined form the logical filename. When files are written with randomly generated logical names in this manner, any relationship among the files should not be detectable by inspection of the logical names, especially when there are many other, unrelated files in the folder or directory that also have filenames that were randomly generated. Indeed, for purposes of making it more difficult for an unauthorized user to extract meaningful information from file segments, it may be desirable to have all DDSS clients' file segments stored in the same directory or folder of a remote storage space. In this way, it will be more difficult to find file segments that are related to each other.

Further steps may be taken to ensure that meaningful information cannot be obtained from the file segments. For example, meta data can be stored at the server, as opposed to with the file segment or directory at the remote node. In some embodiments, file segments written to the same node can be written in a non-sequential, random or intermittent fashion. For example, if FILEA were segmented into six segments with filenames S1, S2, S3, S4, S5 and S6, and designated for storage at nodes A and B, the write sequence may be directed to prevent any two consecutive file segments (i.e., file segments having real data portions that immediate follow each other in the original FILEA) from being written to the same node. Thus, segments S1, S3 and S5 would be written to node A, and segments S2, S4 and S6 would be written to node B. As segment S2 was not stored at the same node as S1 and S3, it should be more difficult to extract meaningful information from the real data in S1 and S3, or the real data in S2, S4 and S6, etc. if the unauthorized user is only able to view data stored at node A or B, respectively.

The write sequence, file segment names, partitioning information for FILEA, e.g., byte offset and size for each data segment, and segment file logical paths are sent to CLIENT2 in SEGMAP at step 305. SEGMAP may also provide an alternative node for a file segment. In the event that the preferred node is unavailable to the client module 20b, although appearing accessible to the server, the client may write to the alternative node instead of the preferred node.

In some embodiments, steps 301 and 312 may be combined and steps 311 and 312 eliminated in FIG. 3. When the server receives information about FILEA from the client at step 301, e.g., the size, name, and client requesting the write, it may also receive the client's requested number of segments and copies for the write. This may be a preferred write process when the client's choice of nodes does not depend on the information reported in NODEINFO. The server may then gather the information it needs from NODEQUERY and then proceed directly to SEGMAP using the information in NODEINFO and the N segments and M copies, which accompanied the initial write request received at step 301. the write process may then proceed to step 305.

At steps 313 and 314 the PARTITION module partitions FILEA according to SEGMAP and the R/W module writes the file segments to the DDSS storage space. preferably, steps 313 and 314 may be carried out at the same time, i.e., a first file segment is partitioned then written to a node, a second file segment is partitioned, then written to a node, etc. After all segments have been written to the remote devices, the WRITEMAP module constructs a MAPFILE indicating the filenames and corresponding logical paths where the data segments were written, the partitioning information from SEGMAP, and file-by-file meta data such as a timestamp. In some embodiments, meta data normally stored with the file is removed and instead stored in the MAPFILE so that an unauthorized user at a remote node cannot use the meta data to re-assemble the real data in the file segments. The amount of meta data that can be stored at the server and not at a node, i.e., not with the local filesystem, may be limited by the filesystem upon which a DDSS operates.

If all files were written to the nodes specified in SEGMAP, and in the order specified by SEGMAP, then MAPFILE is the same as SEGMAP. However, if SEGMAP alternative nodes were used, or the segments were stored in a different order, then MAPFILE will have different file segment information. At step 315 the client module 20b sends MAPFILE to the server and then deletes this file from its memory. If the DDSS was called through an API for an application still running at the client, MAPFILE may remain in RAM at the client and then be removed from memory when the user exits the application.

When MAPFILE is sent to the server at step 315, a successful write is confirmed. At step 306 the information in MAPFILE is stored in a file called “FILEA.DDSS”. As mentioned earlier, the file FILEA.DDSS contains the meta data that enables the re-assembly of FILEA from the file segments and may include, among other things, the file meta data that would normally be stored at the remote node.

In some embodiments, SEGMAP and MAPFILE can be the same file. In these embodiments, the sever module 20a may simply store SEGMAP as FILEA.DDSS and unless a write error is reported by the client, e.g., the client indicates that an alternative node was used, the meta data stored with the server is understood as an accurate mapping for the segments written by the client to the DDSS storage space. If the client R/W module reports, for example, that an alternative node or sequence of writes was used (other than that recommended by the server in SEGMAP), then the client may simply provide an update to SEGMAP, e.g., MAPFILE, which replaces the server's copy of the meta data in FILEA.DDSS.

At step 307 a backup copy of FILEA.DDSS is made by the server. The account manager at the server may then add the logical name FILEA.DDSS.BACKUP to the CLIENT2 account record, indicating the address where a backup of the FILEA meta data may be found.

A read process for FILEA, previously stored by the DDSS write process, may proceed as depicted in FIG. 4. The read process begins when the user at node 2 selects FILEA.DDSS at step 401. “Select” can be a double-click (because the extension “DDSS” is added, the local operating system can easily associate the file with the DDSS client-side application), or a single click with a subsequent selection of “open DDSS file” menu selection, or a “open DDSS file” as an add-in to an application running on the client computer. At step 402 the R/W module reads the contents of FILEA.DDSS, which indicates that N file segments and M copies contain the real-data from file FILEA. “FILEA” is also re-created, either at s:\client2, as a file resident in RAM at the client computer, or as a temporary file accessed by an application running at the client computer. The file may have the same logical name as it did when it was originally placed there by the user. The DDSS read process reads the real-data in the file segments and stores them in FILEA according to the meta data in FILEA.DDSS such that FILEA is identical to the version originally indicated for storage under the DDSS.

FILEA.DDSS may contain information indicating the owner of FILEA, in addition to the information needed to retrieve the FILEA segments, segment copies, and the information needed to re-assembly FILEA from the file segments. One example of FILEA.DDSS is the record 59 depicted in FIG. 6. A first record 60 indicates the ownership of FILEA by the CLIENT2 60a and node 2 address 60b. A second record 62 indicates the user's filename 62a (FILEA), the number of file segments for FILEA 62b (N), and the number of copies of segments 62c (M).

A third record 64 provides N rows of data corresponding to each of the N file segments. The first column 64a indicates the order in which the file segments identified in subsequent columns 64b, 64c and 64d are to be written/were written to the remote nodes. Columns 64b indicate the logical names and logical paths for the file segments, respectively, and columns 64c indicate the start position (as a byte offset) and size (in bytes) of the real data portion in FILEA for the segment, respectively. Columns 64d may provide the meta data related to the most recent read and write of the segment to the remote node. As indicated by the sequence 3, 1, 2, . . . in column 64a, the segments may be written to remote nodes in a non-sequential order for the reasons discussed earlier. As also discussed earlier, the logical filenames may be randomly generated and no consecutive segments, e.g., “name-1” and “name-2”, may be written to the same node.

A fourth record 66 provides M rows of data corresponding to each copy of a file segment in record 64. Some or all file segments may have one or more copies, or levels of redundancy. The first column 66a indicates, as before the order in which the copies identified in subsequent columns 66b, 66c and 64d are to be written/were written to the remote nodes. Columns 66b indicates the logical names and logical paths for the copies, and column 66c indicates which segment from the record 64 corresponds to the copy. Columns 66d may provide the meta data related to the most recent write and read to the remote nodes.

Returning again to FIG. 4, the DDSS read process begins at 403. For each of the N segments, which together contain all real-data from FILEA, the R/W module first checks to see whether the segment “SEG(i)” specified in record 64 is accessible at step 404. If SEG(i) is intact and accessible then it is read into FILEA at step 405, starting at the byte offset specified at 64c in record 64. After all N segments have been read into FILEA, the DDSS read process terminates. If FILEA is too big to hold in virtual memory, then FILEA may be written to temporary storage.

If a node is unavailable, or a segment corrupted or missing, then the R/W module attempts to access the address where a copy is stored at step 406 based on the information in record 66. The R/W module finds the copy of the missing segment from column 66c, then attempts to access the copy using the logical name and path specified in the corresponding field 66b.

At step 407 the R/W module checks to see whether the copy specified in record 66 is available and intact. If yes, then the copy of SEG(i) is read and stored in FILEA as before, and the R/W module turns to the next file segment, i.e., SEG(i+1), and so on. If no, then the R/W returns to record 66 and searches for the next copy of the segment, and so on until a copy of the segment is found. The space reserved for the segments and copies of segments unavailable during the initial read are released when those respective nodes become available again (step 411).

A process for storing a file previously saved to the DDSS is depicted in FIG. 5. The process begins when the DDSS server detects an attempt to store a file having the same name as a previously stored file at step 501. Upon this occurrence, NODEFINO (see FIG. 2A) is called (step 502) to indicate whether the paths in FILEA.DDSS are available for storage at step 503. If all paths are available, then server module 20b directs the client module 20a to use the information in FILEA.DDSS in place of SEGMAP from step 305, and then partition and write FILEA to the specified nodes at steps 313 and 314, as described earlier. Steps 306 and 315 are repeated. If a node address specified in FILES.DDSS is not available, then the write process is repeated from step 303. That is, a revised NODEFINO is sent to the client (step 303), a new set of segments and copies are selected at step 311, etc. When the unavailable nodes become available, the DDSS server deletes the previous segment files at those nodes.

Server module 20a includes a DRIVEINSPECT module for performing housekeeping functions for the DDSS storage space. This module may remove segments or copies of segments that were not accessible and re-written or replaced by alternative or new segments or copies. DRIVEINSPECT receives logical names and paths of segments/copies that R/W module is not able to access. Then, when a node becomes available again, DRIVEINSPECT performs the housekeeping to free-up device space. DRIVEINSPECT may also perform backup functions for client *.DDSS files stored on the server space, and/or monitor remote node disk space directly or through a network server. This module may also be located at a client, as opposed to with the server.

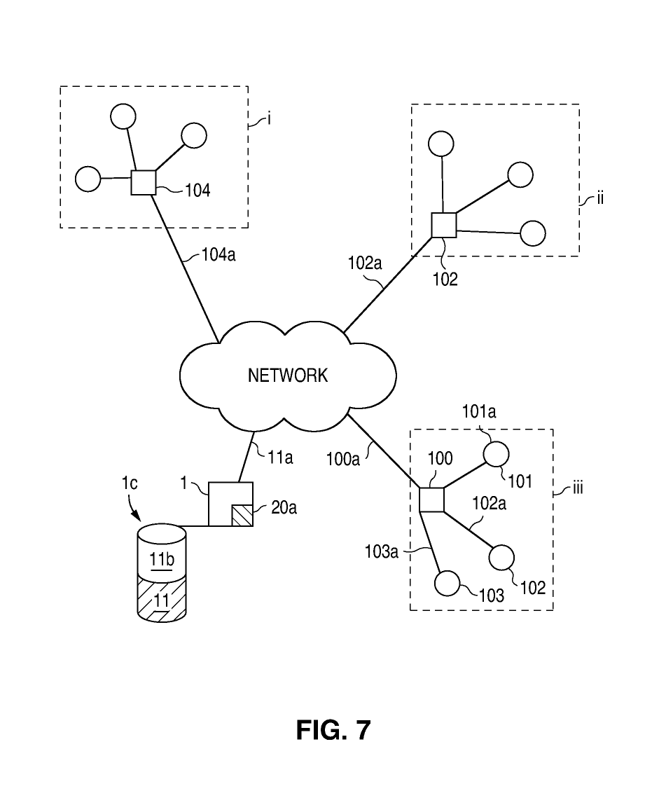

FIG. 7 depicts a second embodiment of a network configured as a DDSS. In this embodiment, the node 1 is, once again designated as the primary DDSS server and has installed locally the server module 20a. Server 1 also has a local storage capacity 1c, with storage 11b allocated for non-DDSS use and a storage space 11 for DDSS server activities, as in other embodiments.

The network depicted may be a centralized network, such as a star network, or a decentralized network, such as a bus or ring network. The network may be any network topology where nodes are typically organized logically or physically into separate domains. For example, the nodes may be organized into physical domains based on the physical location of nodes, connection types between node groups, etc., or logically according to the shared resources or information among nodes, or related functions by members users at the nodes, i.e., sales verses administrative employees of a company.

In some embodiments, the nodes are connected to, or accessible from or to the network according to the different functional groupings of a company. For example, suppose a company has grouped its nodes over the network according to the nodes used, assigned or allocated to sales, marketing, and engineering groups. The network linking all of these groups of the company may then be organized such that nodes 100, 102 and 104 serve as gateway nodes to a group. “Gateway” here is intended to mean a node that connects a first network to a second network or simply a node that provides a serial path connection between groups. In another embodiment, the paths 100a, 102a, 104a which connect the domains i, ii, and iii to the server 1 are not limited to a single serial connection, but rather a separate connection for each of the local domain nodes to one or more of the nodes in or accessible to the network. In this case, the nodes 100, 102 and 104 may therefore represent a network switch connecting each of the nodes in the sales, marketing and engineering groups to all other nodes over the network.

Within each of the domains i, ii, iii there are one or more nodes that are connected to storage devices that are part of a DDSS storage space, and one or more nodes that are DDS enabled clients. The DDSS storage space may include such devices as workstations and printers associated with a domain. Client management and DDSS meta data is stored and managed at server 1 which may be associated with a network server or may simply be one of the nodes of a domain. Within a domain, e.g., domain iii, there are nodes 101, 102, 103 connected to the network through paths 101a, 102a and 103a that, as mentioned earlier, may be connected to the rest of the network by a gateway or a network switch 100. Nodes 101, 102 and 103 may each be DDSS clients, and both DDSS clients and DDSS storage nodes.

The initialization of the DDSS is similar to that discussed earlier. In the case of decentralized network, each client may map the storage space directly by accessing a node. In a centralized network, the client may receive rights to read/write to DDSS nodes through a central server and have a local mapping of the allocated DDSS storage space. The server 1 may gain access to DDSS storage space in the same manner. Similarly, DDSS server space may be requested directly from the server or by a central server for the network.

The read/write priorities, as specified in SEGMAP may prioritize nodes for storage that share the same domain as a DDSS client. For example, the available storage at a local printer may be designated as a default DDSS node for storage for clients that are part of that domain. If the storage at the printer becomes unavailable, then a less preferred node, e.g., a node of another domain, would be selected.

In some embodiments, the DDSS may have a secondary or domain DDSS server node designated at a node within each domain. Each of these domain DDSS servers would receive periodic information about the read/write meta data for members of the domain from the central server 1, as well as copies of the DDSS client accounts at that domain. In the event that the server 1 becomes unavailable, e.g., either by a message received from a DDSS client, or by a failed status request from the backup server to the primary server, the domain DDSS server would become active and assume the roles of the primary server 1 for just that domain. In the event that a backup or domain DDSS server is needed, the DDSS nodes for storage may be limited to the DDSS storage space within the domain.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed is:

1. A method for data storage of a file among at least a network node A and B using an application including a client-side portion residing at a client node and server-side portion residing at a server node, the file residing at the client node and the client node configurable for separate communication links with each of the server node, node A, and node B, comprising the steps of:
the client accessing storage space at the server node after the server recognizes the client as a client of the server;
writing a first data segment of the file to node A and a second data segment of the file to node B, including the steps of:
choosing node A and node B for storage of the first and second data segments, respectively,
generating a segment A filename for the first data segment and a segment B filename for the second data segment, and
the client writing Segment A to node A and Segment B to node B; and
after writing segment A and B, the server saving a map that enables the re-assembly of the file from the first and second data segments.

2. The method of claim 1, wherein the client writing step occurs over a communication link with each of nodes A and B and independent of the server.

3. The method of claim 1, further including the client assigning file names for Segments A and B such that no portion or the logical name of the segment files are relatable to a portion of the logical name of the file.

4. The method of claim 3, wherein the non-relatable file names are generated from a random number.

5. The method of claim 4, wherein the client is adapted for performing at least one of the steps of receiving the logical names from the server and generating the logical names from a random number.

6. The method of claim 1, further including the server selecting nodes A and B based on a node-selection algorithm and recommending nodes A and B to the client.

7. The method of claim 6, wherein the node-selection algorithm selects nodes A and B based on at least one of the following criteria: the level of network traffic at a node, the number of packets errors per transmission to/from a node, the type of storage medium at the node, and the type of communication link between the client node and node.

8. The method of claim 1, further including the server assigning a node score to each of the nodes A and B and the client selecting A and B based on each of the nodes exceeding a threshold node score reflecting a capability for the node to receive the data compared to other nodes over the network.

9. The method of claim 1, further including the client erasing the map after the segment A and segment B data is written to nodes A and B, respectively, and wherein the map relates the data in Segment A and Segment B to the relative locations of the data in the file, and the location of the segment A and segment B on the network, such that the map is needed to form the file from the data in the segment A and segment B files.

10. The method of claim 1, wherein the saving of the map step includes at least one of encrypting the map contents at the server node, and storing the map in a client only, password-protected location at the server node.

11. The method of claim 1, wherein the map includes the segment A and B filenames, the location of nodes A and B, information identifying the client node, and meta data.

12. The method of claim 1, wherein the client node is configurable for separate communication links with a plurality of nodes, including at least the server node, and nodes A and B, further comprising the steps of:
the client requesting from the server the available nodes for data storage and then receiving from the server the availability of the plurality of nodes,
the client segmenting the file into Segments A and B based on the availability of nodes A and B, and
the client writing Segments A and B to the respective nodes A and B, and a copy of the Segment A to a different one of the available plurality of nodes.

13. The method of claim 12, wherein the client node includes an application resident at the client node, wherein the application requests the file, such that if the segment A is not accessible to the client node, the map directs the client to select the copy of segment A from the different one of the available plurality of nodes, and the application reading the copy of segment A.

14. A file storing method for storing a file over a network having a plurality of storage devices at network nodes, the file containing real data, comprising the steps of:
partitioning the real data into a plurality of real data segments;
generating a random filename for each one of the real data segments;
associating each of the real data segments with its respective randomly generated filename; and
storing each of the real data segments on one of the plurality of storage devices.

15. The method of claim 14, wherein the storing step includes storing the metadata needed to reconstruct the file from the data segments at a restricted node on the network, accessible to only the owner of the file.

16. The method of claim 14, wherein the storing step includes storing the real data segments in an order such that no data segment on a node can provide information about the type of information communicated by the data contained in the file.

17. The method of claim 14, wherein the real data segments are partitioned from the file according to a sequential order according to their relative byte locations in the file, and the real data segments are stored on one or more of the plurality of nodes one of a random, intermittent or non-sequential order.

18. The method of claim 14, wherein each of the partitioning, generating, associating and storing steps are carried out by accessing a local filesystem managed by a local operating system.

19. A computer network, comprising
a client node wherein the client is the owner of a file;
a plurality of nodes, each node including a storage space accessible by way of a first communication link comprising communication links between each of the nodes and the client node;
a plurality of data segments, wherein one or more of the data segments are stored on each of the plurality of storage spaces;
a server node having a storage wherein only the server storage has a map enabling the re-assembly of the file from the data segments, and
a second communication link between the client and the server such that the client is enabled for accessing the information needed to re-assemble the file when the client wishes to re-assemble the file from the data segments.

20. The computer network of claim 19, wherein the file is associated with source data comprising the plurality of data segments, further including:
a plurality of redundant data segments stored at one or more of the plurality of storage spaces, such that no copy of a data segment is located at the same node as the respective data segment.

21. A method for a computer to access data associated with a user's file, the data being stored as a plurality of data segments distributed over a network having nodes, and as a plurality of copies of the data segments over the nodes, comprising the steps of
the computer requesting from a network node the locations of the data segments and copies of data segments;
the computer accessing a node in order to retrieve a data segment;
if the node is inaccessible, accessing a different node where a copy of the segment is stored; and
repeating the accessing the copy of the segment at a different node step until a copy of the segment is accessible to the computer.

22. Server software residing on a storage medium, comprising:
a first portion for selecting a plurality of network nodes for storing data portions over a network, wherein data in a source file comprises the data portions;
a second portion for selecting a filename for each of the data portions;
a third portion for storing the relationship between the filenames and the nodes where the data portions reside, and the relationship between the data portions and the data in the source file in a map file; and
a fourth portion for limiting access to the map file to only the owner of the source file.

23. The server software of claim 22, further comprising a server part and a client part, the server part comprising the first, second, third, fourth and fifth portions, and
the client portion being downloadable over a network by a node designated as a client node, and
each of the server and client parts being adapted to run as applications through an interface provided by a local operating system.

24. Client software residing on a storage medium, comprising:
a first portion for selecting a number of data segments for writing data from a source file, the data comprising the data segments;
a second portion for receiving filenames for each of the data segments, and the nodes over a network for storing each of the data segments;
a third portion for writing the data segments to a plurality of nodes using a communication link between a computer where the client software resides and each of the respective nodes;
a fourth portion for communicating the relationship between the filenames and the nodes where the data portions reside, and the relationship between the data portions and the data in the source file; and
a fifth portion for gaining access to a map file on a network node, the map file containing the communicated relationship between the filenames and the nodes where the data portions reside, and the relationship between the data portions and the data in the source file.

25. The client software of claim 24, wherein the fourth portion includes a client password and node identification information for gaining access to the map file, and the fourth portion includes a component for removing the information residing in the map file after all data portions have been successfully written and the relationships communicated to another computer.
